(19) United States
(12) Patent Application Publication
(10) Pub. No.: US 2024/0375373 A1
(43) Pub. Date: Nov. 14, 2024

(54) PREFORM PATCH AND METHOD OF SUBSEQUENT REINFORCEMENT OF A FIBRE COMPOSITE COMPONENT

(71) Applicant: Faserverbund Innovations UG (haftungsbeschränkt), Ibbenbüren (DE)

(72) Inventor: Dominik DIERKES, Ibbenbüren (DE)

(21) Appl. No.: 18/686,095

(22) PCT Filed: Aug. 22, 2022
(86) PCT No.: PCT/EP2022/073334

§ 371 Date: Feb. 23, 2024

(30) Foreign Application Priority Data
Aug. 23, 2021 (DE) 102021121793.8
Aug. 31, 2021 (DE) 102021122535.3
Sep. 2, 2021 (DE) 102021122791.7

(51) Int. Cl. B32B 3/28; B29C 73/10; B29L 31/08; B32B 5/02; B32B 5/26; F03D 1/06

(52) U.S. Cl. CPC B32B 3/28; B29C 73/10; B32B 5/024; B32B 5/026; B32B 5/26; B32B 5/262; F03D 1/0675; B29L 2031/085; B32B 2307/724; B32B 2556/00; B32B 2603/00; F05B 2230/80; F05B 2280/6003

(57) ABSTRACT

The use of a preform patch (2) having, on its side facing the surface of the fiber composite component (8), at least one ply of a tear-off fabric (10) as a first ply, above that at least one ply of a flow aid (12), and above that at least one ply of a vacuum film (14), wherein the at least one ply of the flow aid (12) is disposed in a distributor space (16) for distribution of the matrix material (6) over the fiber layer (4a) of a fiber material bounded on the outside by the vacuum film (14), and the preform patch (2) has a gas permeable but matrix material impermeable membrane (18) and a ply of a spacer fabric (20), wherein the space filled by the spacer fabric (20) forms a suction space (22) sealed in a matrix material tight manner with respect to the distributor space (16).

### CROSS REFERENCE TO RELATED APPLICATIONS

This application claims priority under and is a National Stage of International Application No. PCT/EP2022/073334, filed Aug. 22, 2022, which is herein incorporated by reference in its entirety, including, without limitation, the specification, claims, and abstract, as well as any figures, tables, appendices, or drawings thereof. This application also claims priority under 35 U.S.C. § 119 to German Patent Application DE 10 2021121793.8, filed Aug. 23, 2021, which is herein incorporated by reference in its entirety, including without limitation, the specification, claims, and abstract, as well as any figures, tables, appendices, or drawings thereof. This application also claims priority under 35 U.S.C. § 119 to German Patent Application DE 10 2021122535.3, filed Aug. 31, 2021, which is herein incorporated by reference in its entirety, including without limitation, the specification, claims, and abstract, as well as any figures, tables, appendices, or drawings thereof. This application also claims priority under 35 U.S.C. § 119 to German Patent Application DE 10 2021122791.7, filed Sep. 2, 2021, which is herein incorporated by reference in its entirety, including without limitation, the specification, claims, and abstract, as well as any figures, tables, appendices, or drawings thereof.

### TECHNICAL FIELD

The present invention relates to a preform patch for subsequent reinforcement of a fiber composite component comprising at least one fiber ply of a fiber material and a matrix material of a fiber composite, in which the fiber ply of a fiber material is embedded, wherein the preform patch has at least one ply of a tear-off fabric, and to a corresponding method of subsequent reinforcement of a fiber composite component. The present invention furthermore relates to a method of subsequent reinforcement and/or repair of a blade of a fully installed wind turbine.

### BACKGROUND

The background description provided herein gives context for the present disclosure. The work of the presently named inventors, as well as aspects of the description that may not otherwise qualify as prior art at the time of filing, are neither expressly nor impliedly admitted as prior art.

Fiber composite components that are installed in industrial products have a load bearing capacity defined by their design and construction. After the installation of a fiber composite component in a product, however, it may be found that the original load bearing capacity of the fiber composite component is not adequate in the specific application. It is equally possible that the fiber composite component concerned needs to be subsequently reinforced in its load bearing capacity in order to boost the performance and load bearing capacity of the product. Finally, structural damage may also have occurred in the fiber composite component, damage which limits the original load bearing capacity of the fiber composite component and needs to be rectified by a repair.

EP 2 474 410 A1 discloses the production of a preform patch for repairing parts consisting of a composite material in an automated process. Tailor-made fabric plies are stacked on a tear-off fabric to form a patch, and the patch is inserted into a preform patch, and then a sealed housing is created around the surface at the repair location, and a matrix material is introduced into the repair location by means of the infusion process. In this method, the way in which a preform patch can be configured in order to distribute the matrix material over the surface at the repair location in a reliable process and without the formation of bubbles is left open. In particular, it does not specify in detail where and how the vacuum is applied during the infusion process.

DE 10 2019 121 357 A1 discloses a method for repairing a fiber composite component. For the repair of the damaged location, one or more repair fiber plies are inserted into a repair cavity, and the repair cavity is then infused with a matrix material. Here too, the way in which the repair fiber plies can be arranged relative to one another in order to achieve distribution of the matrix material in a reliable process during infusion is left open.

DE 10 2018 111 306 A1 discloses a method for applying a material to a fiber composite component. In order to prepare a surface of a fiber composite component in the application region of an adhesive for the production of an adhesive joint, the proposal is to lay a monofilament fabric as a tear-off fabric on the surface of the fiber composite component in the application region, to impregnate it with a matrix material, to let it cure and then to tear it off in order to produce a surface with a high surface energy to which other materials can adhere well.

Thus, there exists a need in the art for a preform patch, which is easy to produce, which, by virtue of its special construction, allows the matrix material to flow through the preform patch in a reliable process and is easy to process.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is the object of the present invention to create a preform patch, which is easy to produce, which, by virtue of its special construction, allows the matrix material to flow through the preform patch in a reliable process and is easy to process, and a corresponding method of reinforcement of a fiber composite component.

The object is achieved in the case of a preform patch of the type in question in that the preform patch has, on its side facing the surface of the fiber composite component, at least one ply of a tear-off fabric as first ply, above that at least one ply of a flow medium, and above that at least one ply of a vacuum film, wherein the at least one ply of the flow medium can be arranged in a distributor space for distribution of the matrix material over a fiber ply of a fiber material, the distributor space is delimited on the side facing away from the fiber composite component by the vacuum film, and the preform patch has a gas permeable but matrix material impermeable membrane and a ply of a spacer fabric, wherein the spacer fabric is arranged between the matrix material impermeable membrane and the vacuum film, and wherein the space filled by the spacer fabric forms a suction space, which is sealed in a matrix material tight manner with respect to the distributor space.

The object is achieved in the case of a method of the type in question in that use is made of a preform patch in which there is arranged, on its side facing the surface of the fiber composite component, at least one ply of a tear-off fabric as first ply, above that at least one ply of a flow medium, and above that at least one ply of a vacuum film, wherein the at least one ply of the flow medium is arranged in a distributor space for distribution of the matrix material over a fiber ply of a fiber material, the distributor space is delimited on the side facing away from the fiber composite component by the vacuum film, the preform patch has a gas permeable but matrix material impermeable membrane and a ply of a spacer fabric, wherein the space filled by the spacer fabric forms a suction space, which is sealed in a matrix material tight manner with respect to the distributor space, the preform patch is laid on a fiber ply of a fiber material which has already been laid on the fiber composite component, the preform patch is connected in a vacuum tight manner to the fiber composite component, and matrix material is introduced into the preform patch until the fiber ply of a fiber material is saturated with matrix material, the matrix material cures, and the preform patch is then tom off from the fiber ply of a fiber material along the ply of the tear-off fabric, or the preform patch additionally has a fiber ply of a fiber material as first ply, above that at least one ply of a tear-off fabric, above that at least one ply of a flow medium, and above that at least one ply of a vacuum film, a gas permeable but matrix material impermeable membrane, and a ply of a spacer fabric, wherein the spacer fabric is arranged between the matrix material impermeable membrane and the vacuum film, and wherein the space filled by the spacer fabric forms a suction space, which is sealed in a matrix material tight manner with respect to the distributor space, and the preform patch with the fiber layer of a fiber material is laid directly on the surface of the fiber composite component, the preform patch is connected in a vacuum tight manner to the fiber composite component, and matrix material is introduced into the preform patch until the fiber ply of a fiber material is saturated with matrix material, the matrix material cures, and the preform patch is then tom off from the fiber ply of a fiber material along the ply of the tear-off fabric.

The object is achieved in the case of a method of the type in question for subsequent reinforcement and/or repair of a blade of a fully installed wind turbine in that a fiber ply of a fiber material as first ply, above that at least one ply of a tear-off fabric, above that at least one ply of a flow medium, and above that at least one ply of a vacuum film are applied to the surface of the blade on the side to be repaired and/or reinforced, wherein the at least one ply of the flow medium is arranged in a distributor space for distribution of the matrix material over a fiber ply of a fiber material, the distributor space is delimited on the side facing away from the blade by the vacuum film, and the distributor space has a gas permeable but matrix material impermeable membrane and a ply of a spacer fabric, wherein the spacer fabric is arranged between the matrix material impermeable membrane and the vacuum film, and the space filled by the spacer fabric forms a suction space, which is sealed in a matrix material tight manner with respect to the distributor space, the above described material ply is connected in a vacuum tight manner to the fiber composite component, and matrix material is introduced into the material ply until the fiber ply of a fiber material is saturated with matrix material, the matrix material cures, and the material ply, with the exception of the fiber ply of a fiber material is then tom off from the fiber ply of a fiber material along the ply of the tear-off fabric, without detaching the blade from the wind turbine during this process.

The preform patch forms a plaster, which is laid, at a location to be reinforced, on the fiber ply of a fiber material, which, for its part, has been laid on the surface of the fiber composite component. At least one ply of the tear-off fabric, the at least one ply of the flow medium, and the at least one ply of the vacuum film are fully incorporated into the preform patch. The preform patch can be pre-produced in its entirety at low cost, and therefore, it is no longer necessary to cut out, lay, and align the individual material plies, which are already contained in the preform patch. In particular, the preform patch can be pre-produced to precisely fit the respective application, thus, for example, when an identical quality of work combined with high process reliability is required for relatively large production numbers. Faults due to individual manual processing are avoided. The respective material plies can be welded, adhesively bonded, or stitched to one another or connected to one another in some other suitable manner, it being necessary to ensure, in the case of stitching, that the stitching holes in the vacuum film and the membrane are adequately sealed.

The peripheral shape and size of the preform patch can easily be adapted to the respective use. That also applies to the selection of materials and to the dimensioning and number of the respective plies of the preform patch.

The preform patch must be sealed off in an airtight manner with respect to the environment at its outer sides before the matrix material can be drawn into the distributor space within the preform patch by means of a vacuum. The material plies of the preform patch can be welded or adhesively bonded in a gastight manner on the outer sides of said patch, even before connection to the fiber composite component, ensuring that it is already gastight per se in the edge regions, and/or the preform patch is stuck onto the surface of the fiber composite component by means of a gastight adhesive tape, in particular in the regions in which the lateral edges are open. However, such a work step can be performed quickly and easily, and the risk of errors in carrying it out is low. Since the fiber ply of a fiber material of the preform patch cannot be sealed in a gastight manner, it must, in all cases, be connected in a gastight manner to the surface of the fiber composite component before being used, e.g., by means of adhesive tapes.

By virtue of the special layering of the respective material plies of the preform patch, the at least one ply of the tear-off fabric rests directly on the fiber ply of a fiber material, which has been laid on the surface of the fiber composite component or which is a constituent of the preform patch. When the matrix material has been introduced into the preform patch, it is distributed over the surface of the fiber ply of a fiber material via the flow medium with a flow front, which moves across the surface of the preform patch, and it seeps into the fiber ply of a fiber material, crosslinks with the latter and with the surface of the fiber composite component, and then cures.

The vacuum film is gastight and matrix material tight, and therefore the matrix material can be distributed over the entire surface below said film in the distributor space without material losses of the matrix material occurring. By virtue of its barrier effect, however, the vacuum film also promotes the distribution of the matrix material within the distributor space because the flow front of the matrix material moves along it through the distributor space. By virtue of its configuration, however, the vacuum film cannot separate gas components from the matrix material. After the curing of the matrix material, the preform patch with the tear-off fabric can simply be tom off in a single operation from the fiber composite component, and the fiber material ply freshly applied thereto. By means of the layering according to the invention of the plies of the preform patch, the only thing that remains on the fiber composite component after the tearing off of the other plies along the tear-off fabric is the fiber ply of a fiber material together with the matrix material, which surrounds the latter and then cures, in order to reinforce said fiber composite component.

An important constituent of the preform patch is the membrane, which separates the distributor space from the suction space. Although the membrane is not gastight owing to an appropriately small microperforation, it does prevent the passage of the long chain molecules of the liquid matrix material supplied. It may be regarded as an advantage of the preform patch that the suction space is already integrated and ready for installation into the preform patch. By virtue of the integration of the suction space into the preform patch, the installation and use of the preform patch are simplified. Installation errors and any leaks are thereby avoided. The vacuum in the distributor space is produced by means of the material ply with a gas-permeable but matrix material impermeable membrane and the spacer fabric. The spacer fabric in the suction space serves as a spacer, which prevents the membrane from coming to rest flat against the vacuum film under the action of the vacuum, with the result that the suction space collapses and the gas flow out of the distributor space is thereby interrupted. In this context, the concept of the spacer fabric should be interpreted broadly. It is not limited to a fabric in the literal sense but covers everything which, on the one hand, keeps the membrane and the vacuum film apart and nevertheless allows a gas flow through the suction space, including, for example, also nonwovens, shaped bodies that are porous and gas permeable in the direction of extent, and the like.

If a vacuum is applied to the suction space via a suction connection, the vacuum, which arises, draws the matrix material flowing into the distributor space away from the inflow connection in the direction of the membrane. Since the membrane is configured to be matrix material impermeable but gas permeable, a gas that is situated in the distributor space can be extracted completely or at least almost completely, whereas the matrix material is retained in the distributor space. Depending on how the flow front of the matrix material moves across the surface of the preform patch during this process, matrix material accumulates at the membrane where the flow front has reached the membrane. The membrane should, therefore, be arranged in regions of the preform patch and of the fiber composite component in which no further wetting of a fiber ply of a fiber material is required. As a flow front progresses, this ensures that only gas is extracted there from the distributor space via the suction space, and that matrix material is sucked in where the distributor space is still not yet completely filled with matrix material, until the entire surface of the membrane is covered with the accumulated matrix material. In this way, it is possible to achieve a high process quality with low gas inclusions in the matrix material in which the fiber ply of a fiber material is embedded.

The spacer fabric, like the ply of the tear-off fabric, the ply of the flow medium, and the ply of the vacuum film, is preferably but not necessarily produced from a flexibly deformable material, thus enabling the preform patch to adapt to any surface contours of the fiber composite component when used.

In particular, a preform patch can have a plurality of plies of a flow medium. In particular, the flow medium can be of multi-ply designs where a higher speed of flow of the matrix material is desired. The multi-ply structure may, therefore, also be formed in only some region or regions. Flow media that are of multi-ply designs can also form pockets between them, which have a larger delivery cross-section than a single-ply flow medium.

The fiber ply of a fiber material laid on the fiber composite component contains the reinforcing fibers, which impart a higher strength to a fiber composite component. It is here that the fibers known for use in fiber composite components, such as glass fibers, carbon fibers, aramid fibers, and the like, can be used. The fiber ply is configured in a manner that appears appropriate for the respective use. The fibers can be in woven or knitted form or in a random orientation. They can be aligned in such a way that an increased strength is obtained in a particular direction of loading. It is also possible to use a plurality of fiber plies one above the other or fiber plies with different types of fiber.

The preform patch is suitable, in particular, for repairing and/or subsequently reinforcing particularly large fiber composite components, also including blades of wind turbines, for example. Through the use of a preform patch according to the invention, it is possible to carry out the repair and/or subsequent reinforcement of the large fiber composite component, such as a blade on a wind turbine set up ready for operation, without the need for this purpose to remove the blade, lay it on the ground, carry out the repair and/or the reinforcement and then reattach the blade to the wind turbine.

According to one embodiment of the invention, the preform patch additionally has a fiber ply of a fiber material as first ply, above that at least one ply of a tear-off fabric, above that at least one ply of a flow medium, and above that at least one ply of a vacuum film. In this embodiment, which can also be used in an appropriately adapted method or in the repair of a large composite component, such as the blade of a wind turbine, the fiber ply of a fiber material is a constituent of the preform patch. In this case, the fiber ply, together with the other material plies of the preform patch, is laid as an assembly part on the surface of the fiber composite material, more specifically with the fiber ply as the layer, which comes into direct contact with the surface, and above that the other layers of the preform patch in the sequence claimed. The operation of laying the fiber ply separately on the surface of the fiber composite component is eliminated. By connecting the various material plies in a prefabricated preform patch, it is possible to match the correspondingly used materials to one another in an optimum manner, and the risk associated with the joint use of mutually incompatible materials, which exists in the case of separate laying of a material ply separate from the preform patch, is eliminated. For this combination of material plies, with the inclusion of the fiber ply into the preform patch, the advantages described above apply in corresponding fashion.

According to one embodiment of the invention, the material ply with the membrane and the spacer fabric is arranged in at least one edge region of the flow medium, overlapping at least partially with the latter. As a result of this overlap, the matrix material is brought up to the membrane. If the flow medium does not completely overlap the material ply, a kind of braking zone is obtained for the matrix material, in which zone the flow front of the matrix material runs out. If the braking zones are formed outside or in the edge region of the regions in which the fiber ply of a fiber material is situated, the fiber ply is reached and wetted completely by the matrix material.

According to one embodiment of the invention, the preform patch has an inlet connection and a suction connection. The inlet connection for the matrix material is connected to the preform patch to enable the matrix material to be introduced into the distributor space via said connection. The suction connection is connected to the suction space to enable the vacuum to be applied to it. The inlet connection and the suction connection can be supplied as standardized shaped parts, which can be connected gas tightly to the preform patch by means of an adhesive tape. This significantly simplifies and accelerates installation.

According to one embodiment of the invention, the preform patch has a gas-permeable but matrix material impermeable membrane and a ply of a spacer fabric only in some region or regions. Since the preform patch has a gas-permeable but matrix material impermeable membrane and a ply of a spacer fabric only in some region or regions, it is possible to save membrane material but, in particular, it is possible to draw matrix material from a region in which there is no membrane into the region in which the membrane is present. Particularly if the matrix material is fed in a region in which there is no membrane, the matrix material can be distributed better over the surface of the preform patch. It is, therefore, advantageous to spatially match the region of the preform patch in which the matrix material enters and the region in which the membrane is arranged to one another in such a way that good distribution of the matrix material over the surface of the preform patch is obtained.

According to one embodiment of the invention, a ply of the flow medium in one section of the preform patch is situated in a plane, which is different from the plane of the ply of the flow medium which rests on the fiber ply of a fiber material, wherein one end of the flow medium situated in the different plane enters the plane of the ply of the flow medium which rests on the fiber ply of a fiber material. Particularly in the case of relatively large components, which are to be reinforced, there can be the problem that the matrix material begins to cure even before the flow front of the matrix material has spread out over the entire surface of the fiber ply of a fiber material. Those regions of the fiber ply which the flow front of the matrix material has not yet reached would then possibly no longer be wetted by matrix material, and it would therefore no longer be possible to produce a fiber composite there. Such an attempt at reinforcement or repair would have to be regarded as a failure, with the result that it would be necessary to remove even those regions of the fiber ply of a fiber material which were impregnated by the matrix material from the fiber composite component again, and a renewed attempt to reinforce or repair the fiber composite component would be necessary. To avoid such failures, it is advantageous to create zones in the preform patch in which the matrix material can flow more quickly than in other regions. If at least one ply of the flow medium is situated in the preform patch in a plane, which is different from the plane in which the ply of the flow medium, which rests on the fiber ply, is arranged, the matrix material can flow forward on this ply of the flow medium without a relatively large fraction of the material in the matrix material flow seeping away into the fiber ply of a fiber material. The ply of the flow medium, which is arranged in a different plane, together with the matrix material collected therein, forms a hydrostatic column in which the matrix material can flow more quickly through the flow medium on account of gravity and the weight of the upstream matrix material. It is possible, in particular, for the ply of the flow medium, which is arranged in the different plane, to be designed as a web which protrudes from the rest of the preform patch. As a result, while the same size dimensions of the channels are retained, the matrix material can reach the regions of the preform patch, which are further away from the inlet connection more quickly than is possible via the regions in which at least some of the matrix material seeps away into the fiber ply. By virtue of the flow medium arranged in a different plane, the matrix material can thus more quickly get into the regions which are further away from the inlet connection before the begins to cure. Of course, the flow medium arranged in a different plane is also covered with respect to the outside by at least one vacuum film, thus ensuring that no losses of matrix material can occur there and that the vacuum applied in the suction space reaches into the flow medium situated in the different plane.

However, if one end of the flow medium situated in the different plane enters the plane of the ply of the flow medium, which rests on the fiber ply of a fiber material, it is still possible for matrix material transported in the different plane to seep into the ply of the flow medium which rests on the fiber ply and to be distributed further there. Depending on how the transition from the ply of a flow medium, which is arranged in the different plane into the ply of the flow medium which rests on the fiber ply, is configured, more or less matrix material gets into the region of the flow medium via the fiber ply during this process. Thus, the flow media can be designed to be contact-free, merely to abut one another or even to overlap to a greater or lesser extent in the region of entry.

The ply of the flow medium, which is arranged in a different plane, can be located in a tab which is movable relative to the rest of the preform patch. Thus, the tab can rest flat on the rest of the preform patch in a space-saving manner before use, and swing away sideways when it is filled with matrix material. The flow medium arranged in the different plane then has enough space to expand and, in the process, to accept a larger volume of matrix material. In this way, the ply of the flow medium, which is arranged in a different plane, forms a separate conduit for delivering the matrix material.

According to one embodiment of the invention, the ply of the flow medium, which is arranged in the different plane, is laid in a loop. In the region of the loop or of a fold, the ply of the flow medium is in at least double-ply form in a plane of the loop in the preform patch. After being filled with matrix material, a flow medium laid in a loop or fold forms a channel with a cross-section, which is approximately round but, in all cases, is enlarged and in which a larger quantity of matrix material can be transported. The looped or folded flow medium surrounds an interior space, which may also be able to expand more easily. One or two opposite ends of the loop can be embodied so as to overlap in some region or regions with the ply of the flow medium, which rests on the fiber ply in order to transfer matrix material transported in the loop more effectively into the surface of the preform patch.

According to one embodiment of the invention, the ply of the flow medium, which is arranged in the different plane, and the gas-permeable but matrix material impermeable membrane with the ply of a spacer fabric run at a distance from and in an at least approximately parallel alignment with respect to one another over the length of the preform patch. While the ply of the flow medium, which is arranged in the different plane, transports the matrix material along it at a relatively high speed over the length of the preform patch and distributes it from there in a direction transverse to the direction of the longitudinal extent of the flow medium arranged in the different position, the gas permeable but matrix material impermeable membrane with the ply of a spacer fabric serves to form the suction space to which the vacuum is applied and via which the matrix material is drawn in the direction of the suction space. By virtue of the at least approximately parallel course, in the direction of longitudinal extent, of the flow medium arranged in the different position and of the suction space covered by the membrane, the matrix material can be distributed quickly and effectively over the surface of the preform patch, both in the direction of longitudinal extent and in a direction transverse to the flow medium arranged in the different position.

According to one embodiment of the invention, at least two plies of vacuum films form the outer skin of the preform patch, wherein the two plies are separated from one another by a suction web arranged between them. If the inner ply of the vacuum film is leaky at individual locations, the outer ply of the vacuum film still keeps the preform patch sufficiently leak-tight with respect to the outside, wherein the matrix material emerging from the inner ply of the vacuum film can be extracted and collected via the suction web.

According to one embodiment of the invention, the preform patch is stored in roll form. On a roll, it is also possible to roll up relatively long lengths of material, e.g., lengths of material of 50 m and more. The length of matrix material rolled up onto the roll can be unrolled at the location of use and cut to a suitable length that is sufficiently long for the planned use. The preform patch stored on the roll can also be configured to precisely the appropriate length for the intended use, eliminating the need to perform any shortening work at the construction site. This makes it possible to speed up installation.

According to one embodiment of the invention, the preform patch is laid on a surface of the fiber composite component, which is not aligned horizontally, and the matrix material is introduced into the preform patch at the upper end of the preform patch. In this arrangement of the preform patch, gravity is used to help the matrix material flow into the preform patch and to be distributed therein. Particularly when the preform patch is aligned with the ply of the flow medium almost or precisely vertical, the matrix material reaches comparatively high speeds of flow. Particularly in the case of very large components, such as the rotor blades of wind turbines, the flow distances for the matrix material along the length of an individual rotor blade during infusion of the matrix material into the preform patch from above may be 40-50 m, for example. Even with an applied vacuum, such flow distances require a propagation time during which the matrix material is already beginning to cure, especially since, in addition to the flow distances in the direction of extent, the matrix material must, of course, still penetrate without bubbles into the fiber ply of a fiber material and must crosslink with the latter and with the surface of the fiber composite component. The preform patch makes it possible to use gravity as a delivery aid for the inflow of the matrix material into the preform patch.

Another advantage when using the preform patch on a surface, which is not horizontally aligned, may be regarded as the fact that, given an appropriate vertical in flow rate, a liquid column in which a static pressure builds up is built up in the flow medium. The static pressure in the liquid column promotes the seeping of the matrix material into the fiber ply of a fiber material. By this means too, the distribution of the matrix material within the preform patch is promoted and accelerated.

It is also advantageous that the preform patch can be used on very large but also on relatively small components without having to remove the component to be reinforced and move it into a horizontal position. On the contrary, the component to be reinforced can be reinforced with the preform patch on site in an installed state by laying the preform patch on the component to be reinforced, sealing it, and flooding it with matrix material. This can be done at a much lower cost than by removing large components from an installation, processing them, and then reinstalling them in an installation.

According to one embodiment of the invention, the feed rate of the matrix material into the preform patch is controlled in such a way that an excess supply of matrix material is formed in the region of the flow medium at the front end of the flow front and/or in an intermediate portion of the preform patch when viewed in the direction of flow. If the feed rate of the matrix material is controlled in such a way that an excess supply of matrix material is formed at the front end of the flow front and/or in an intermediate portion of the preform patch, a reservoir of matrix material that can flow out of the flow medium into the fiber ply of a fiber material is formed in this region. In this way, the inflow and buffering of matrix material can be limited to the regions in which inflowing matrix material is actually required. Thus, the inflowing quantity of matrix material can also be throttled in order to avoid overloading the absorption capacity and holding capacity of the flow medium. Particularly in the case of relatively large component dimensions, it would be possible in the case of an uncontrolled supply of the matrix material for liquid columns of 20, 30, or 40 m to arise, the pressure of which the preform patch would not be able to withstand. A kind of wave control can help to avoid too much matrix material accumulating in the preform patch.

According to one embodiment of the invention, the preform patch has a gas-permeable but matrix material impermeable membrane and a ply of a spacer fabric only in some region or regions, and the preform patch is aligned with the fiber composite component in such a way that the suction space formed by the membrane and the spacer fabric sucks the matrix material through the distributor space in a direction transverse to the horizontal. In this embodiment, the transverse distribution of the matrix material in the preform patch is assisted by the extraction of the gas situated in the distributor chamber through the membrane. Here, the transverse distribution is effective in the region, which is not covered by the membrane. It is advantageous to arrange the membrane in a lateral edge region of the preform patch because this ensures that the transverse distribution by the vacuum applied in the suction space acts across the width of the preform patch. The distribution of the matrix material in the vertical direction can be assisted, in particular, by gravity.

According to one embodiment of the invention, in the preform patch used, a ply of the flow medium in one section of the preform patch is situated in a plane, which is different from the plane of the ply of the flow medium which rests on the fiber ply of a fiber material, wherein one end of the flow medium situated in the different plane enters the plane of the ply of the flow medium which rests on the fiber ply of a fiber material, and the feeding of the matrix material is controlled in such a way that a reservoir column of matrix material is formed in the differently laid ply of the flow medium, at least in some section or sections. The flow medium arranged in the different position forms a kind of tab, which is raised when filled with matrix material and serves as a resin conduit in order to transport the matrix material quickly to those locations of the preform patch which are further away from the inlet connection. Here, the control of the inflow of matrix material can be performed in such a way that a liquid column flowing in the vertical direction is obtained in the ply of the flow medium, which is situated in the different plane, more specifically also only in some section or sections, in order to obtain better process control.

Further features of the invention will become apparent from the claims, the figures, and the description of the subject matter. All the features and combinations of features mentioned above in the description and the features and combinations of features mentioned below in the description of the figures and/or shown in the figures alone can be used not only in the respectively specified combination but also in other combinations or in isolation.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated. The invention will now be explained in detail by means of a preferred exemplary embodiment with reference to the appended drawings. In the drawings:

FIG. 1 shows a schematic cross-sectional view of a preform patch.

FIG. 2 shows a view of a wind turbine.

FIG. 3 shows a view of the blade of a wind turbine with the preform patch applied.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

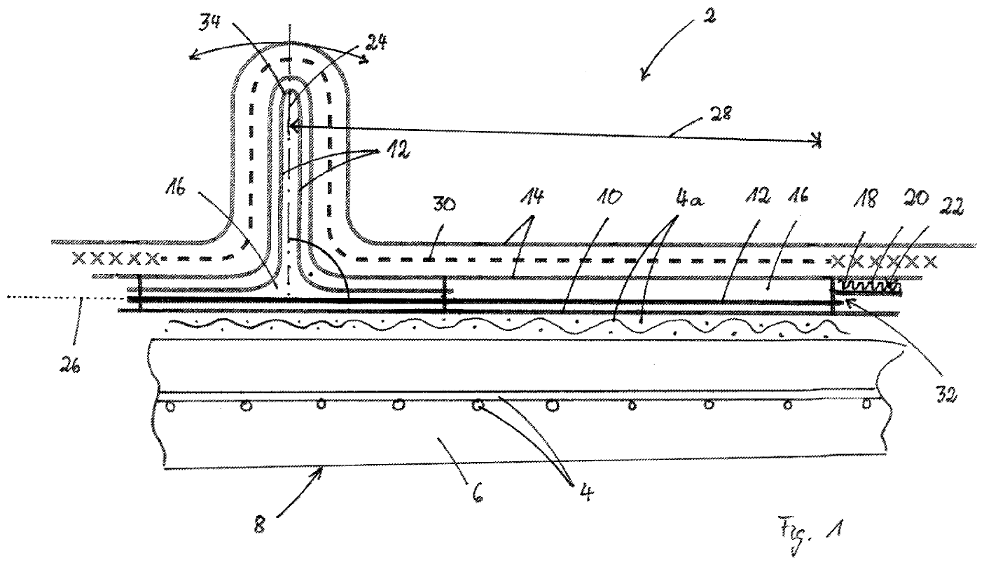

FIG. 1 shows a schematic cross-sectional view of a preform patch 2 with the various plies of the materials contained therein. In the illustration in FIG. 1, the preform patch 2 is laid on a fiber composite component 8 which comprises a fiber ply 4 of a fiber material, which is embedded in a matrix material 6. In order to reinforce the fiber composite component 8 with a material structure comprising an additional fiber ply 4a of a fiber material, a new fiber ply 4a of a fiber material is laid on the surface of the fiber composite component 8. The other material plies of the preform patch 2 are then laid on this fiber ply 4a in order to crosslink the fiber ply 4a to matrix material 6 via the preform patch 2 in a further method step. During this process, the new fiber ply 4a can be part of the preform patch 2, but the fiber ply 4a can also be laid on the surface of the fiber composite component 8 separately from the preform patch 2.

A ply of a tear-off fabric 10 is first of all laid on the fiber ply 4a of a fiber material. A ply of a flow medium 12 is laid on the tear-off fabric 10. In the exemplary embodiment, two plies of a vacuum film 14 are, in turn, laid on the flow medium 12. The vacuum film 14 delimits the distributor space 16 in which the flow medium 12 is situated on the side facing away from the fiber composite material 8. Matrix material 6, which is introduced into the distributor space 16, can propagate along the flow medium 12 in the distributor space 16 and seep out of the flow medium 12 into the fiber ply 4a of a fiber material. In this way, the preform patch 12 is used to impregnate the fiber ply 4a of a fiber material with matrix material 6. Once the matrix material 6 supplied in liquid form has cured, the supplied matrix material 6, together with the new fiber ply 4a, forms a fiber composite, which reinforces the fiber composite component 8. After the matrix material 6 supplied has cured, the preform patch 2 can be torn off from the newly constructed fiber composite along the tear-off fabric 10.

In order to generate a vacuum in the distributor space 16, the preform patch 2 has a gas-permeable but matrix material impermeable membrane 18 and a ply of a spacer fabric 20, wherein the space filled by the spacer fabric 20 forms a suction space 22, which is sealed off from the distributor space 16 in a matrix material tight manner. A vacuum can be applied to the suction space 22, said vacuum enabling gas to be extracted from the distributor space 16 through the membrane 18. By means of the vacuum which acts through the membrane 18 into the distributor space 16, the matrix material 6 is better distributed in the distributor space 16 since it draws the supplied matrix material 6 as far as the membrane 18. The material ply with the membrane 18, and the spacer fabric 20 is arranged laterally at the edge of the preform patch 2. As a result, the preform patch 2 has a gas permeable but matrix material impermeable membrane 18 and a ply of a spacer fabric 20 only in some region or regions. The membrane 18 and the spacer fabric 20 are situated at a distance 28 from the ply of the flow medium 12, which is arranged in a different plane 24. The extent of the gas permeable but matrix material impermeable membrane 18 also advantageously runs over the length of the preform patch 2 in an at least approximately parallel alignment with respect to the ply of the flow medium 12, which is arranged in a different plane 24. As a result, when, for example, the matrix material 6 introduced into the distributor space 16 seeps into the distributor space 16, in particular via the loop 34, it is sucked almost completely in the transverse direction over the surface of the fiber layer 4a of a fiber material, and during this process can seep well into the fiber ply and crosslink with the latter and with the material of the surface of the fiber composite component 8. By virtue of the membrane 18 being present only in some region or regions, the distribution of the matrix material 6 within the distributor space 16 can, therefore, be influenced in a specifically intended manner. In the exemplary embodiment, the membrane 18 furthermore overlaps at least partially with the flow medium 12 in the region of overlap 32 in order to bring the flow front of the matrix material 6 as far as the membrane 18. In the region of overlap 32, the flow medium 12 is not extended completely over the surface of the membrane 18 in order thereby to form a braking zone in which the flow front of the liquid matrix material 6 can run out and stop.

The illustration shown in FIG. 1 is graphically simplified. The sealing of the preform patch 2 at the sides is not illustrated specifically. In order to seal off the distributor space 16 and the suction space 22, the lateral edges of the preform patch 2 are bonded onto the surface of the fiber composite component 8 and sealed off, for example, by means of gastight and matrix material tight adhesive tapes.

The two plies of a vacuum film 14, which are shown in the exemplary embodiment, are separated from one another by a suction web 30. If the first ply of the vacuum film 14 starts to leak toward the distributor space 16 at one point, gas that escapes there and/or matrix material 6 that escapes there can be extracted via the suction web 30. Of course, as a departure from the exemplary embodiment, the preform patch 2 can also have just one ply of a vacuum film 14.

It is clearly apparent in FIG. 1 that the flow medium 12 is laid in a loop 34 in one region of the preform patch 2. In the illustrative depiction shown in FIG. 1, the loop 34, with the double-ply flow medium 12 contained therein, is raised at a right angle with respect to the plane 26 in which the ply of the flow medium 12, which rests on the fiber ply 4a of a fiber material is aligned. As a result, the flow medium 12 laid in the loop 34 is situated in a plane 24, which is different from the plane 26 of the ply of the flow medium 12, which rests on the fiber ply 4a of a fiber material. As a departure from the exemplary embodiment, the flow medium situated in the different plane 24 can also be set at any desired angle other than 90° to the right or to the left, as the double arrow on the loop 34 indicates, and can even be so far to the left or right that the loop 34 rests flat on the rest of the preform patch 2. Particularly when filling with the matrix material 6 supplied, the loop 34 can rise, swell, and, in this way, form a suitable delivery conduit for the rapid transport of the matrix material 6 supplied. One end of the flow medium 12 situated in the different plane 24 enters the plane 26 of the ply of the flow medium 12, which rests on the fiber ply 4 of a fiber material. In the exemplary embodiment, the flow medium 12 laid in a loop 34 is furthermore designed as a separate ply of a flow medium 12. By virtue of the contact of the flow media in the region of entry, the outflow of the matrix material 6 from the region of the loop 34 into the distributor space 16 is promoted.

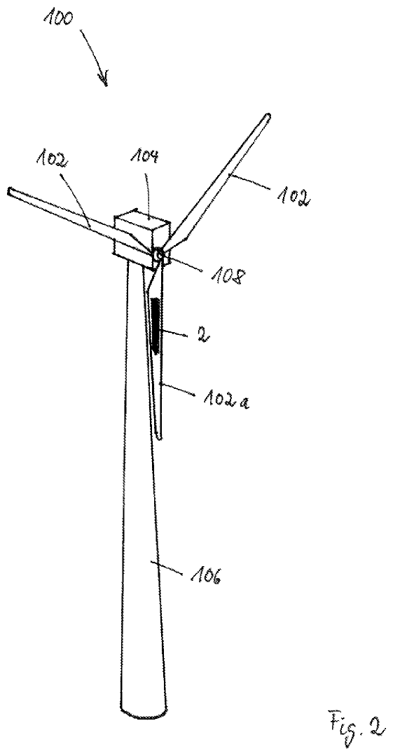

FIG. 2 shows a view of a wind turbine 100 with three blades 102, of which blade 102a points downward from the rotor shaft 108 in the direction of the longitudinal extent of the blade. A preform patch 2 is laid on the surface of the blade 102a in order to repair and/or reinforce the blade 102a. The blade 102a remains installed on the rotor shaft 108 when the preform patch is flooded with matrix material. The rotor shaft 108 is mounted in the turbine casing 104. The turbine casing 104 is mounted on a tower 106.

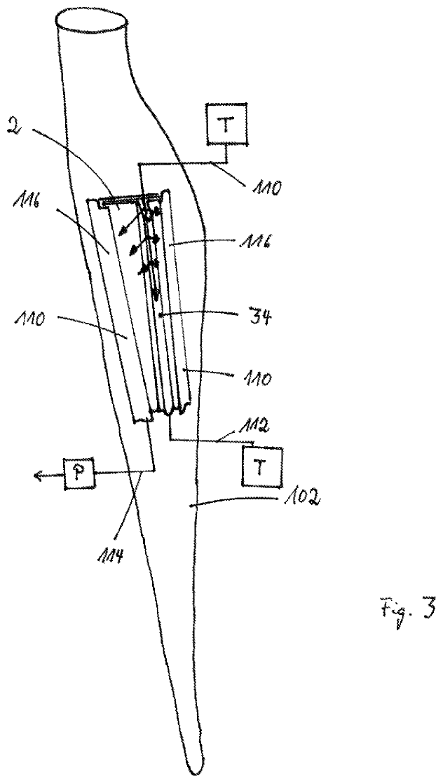

FIG. 3 shows a view of the blade 102 of the wind turbine 100 with the preform patch 2 placed thereon, in an enlarged illustration. In the enlarged illustration in FIG. 3, it is apparent that the matrix material 6 can run out of the tank T into the preform patch 2 via the inlet connection 110. The distribution of the matrix material 6 within the preform patch 2 during flooding with the matrix material 6 is indicated by arrows. According to this, the matrix material 6 runs downward, in particular through the loop 34, in the direction of the outlet connection 112, to which another tank T can be connected. From the loop 34 but also via the flow medium 12 contained in the preform patch 2, the matrix material is also distributed in a lateral direction, however, in particular toward the suction space 22 formed in the interior of the preform patch 2. During this process, good transverse distribution of the matrix material within the distributor space 16 is also obtained. The air evacuated from the interior of the preform patch 2 and from the gas bubbles in the matrix material by means of the vacuum pump P can be discharged from the suction space 22 via the suction connection 114. It is thus apparent that it is easily possible with a preform patch 2 to reinforce or repair the blade 102 of a wind turbine 100 with a fiber ply 4 of a fiber material embedded in a matrix material 6, without the need to remove the blade 102 from the wind turbine 100. It is sufficient to lay the preform patch 2 on the surface of the blade, to secure and seal it by means of adhesive tape 116, to install the connections, and then to extract the air from the preform patch 2, to introduce matrix material into the preform patch 2 and allow it to cure, and after this to tear-off the preform patch 2 along the tear-off fabric. If a blade 102 is pointing downward, it is furthermore possible in this context also to exploit gravity to distribute the matrix material 6 particularly quickly over the length and area of the preform patch 2.

The invention is not restricted to the exemplary embodiments above. A person skilled in the art will have no difficulty in modifying the exemplary embodiments in a manner that appears suitable to them in order to adapt them to a specific application. From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 2 | Preform patch |
| 4 | Fiber ply |
| 4a | Additional fiber ply |
| 6 | Matrix material |
| 8 | Fiber composite component |
| 10 | Tear-off fabric |
| 12 | Flow medium |
| 14 | Vacuum film |
| 16 | Distributor space |
| 18 | Membrane |
| 20 | Spacer fabric |
| 22 | Suction space |
| 24 | Different plane |
| 26 | Plane in contact |
| 28 | Distance |
| 30 | Suction web |
| 32 | Region of overlap |
| 34 | Loop |
| 100 | Wind turbine |
| 102 | Blade |
| 102a | Downward pointing blade |
| 104 | Turbine casing |
| 106 | Tower |
| 108 | Rotor shaft |
| 110 | Inlet connection |
| 112 | Outlet connection |
| 114 | Suction connection |
| 116 | Adhesive tape |
| P | Vacuum pump |
| T | Tank(s) |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through the use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, sub-combinations, or the like that would be obvious to those skilled in the art.

1-19. (canceled)

20. A preform patch (2) for subsequent reinforcement of a fiber composite component (8) comprising:
at least one fiber ply (4) of a fiber material and a matrix material (6) of a fiber composite, in which the fiber ply (4) of a fiber material is embedded, wherein the preform patch (2) has at least one ply (10) of a tear-off fabric (10), characterized in that the preform patch (2) has, on its side facing the surface of the fiber composite component (8), at least one ply of a tear-off fabric (10) as first ply, above that at least one ply of a flow medium (12), and above that at least one ply of a vacuum film (14), wherein the at least one ply of the flow medium (12) can be arranged in a distributor space (16) for distribution of the matrix material (6) over a fiber ply (4a) of a fiber material, the distributor space (16) is delimited on the side facing away from the fiber composite component (8) by the vacuum film (14), and the preform patch (2) has a gas permeable but matrix material impermeable membrane (18) and a ply of a spacer fabric (20), wherein the spacer fabric (20) is arranged between the matrix material impermeable membrane (18) and the vacuum film (14), and wherein the space filled by the spacer fabric (20) forms a suction space (22), which is sealed in a matrix material tight manner with respect to the distributor space (16).

21. The preform patch (2) for subsequent reinforcement of a fiber composite component (8) according to claim 20, wherein the preform patch (2) additionally has a fiber ply (4a) of a fiber material as first ply, above that at least one ply of a tear-off fabric (10), above that at least one ply of a flow medium (12), and above that at least one ply of a vacuum film (14).

22. The preform patch (2) for subsequent reinforcement of a fiber composite component (8) according to claim 20, wherein the material ply with the membrane (18) and the spacer fabric (20) is arranged in at least one edge region of the flow medium (12), overlapping at least partially with the latter.

23. The preform patch (2) for subsequent reinforcement of a fiber composite component (8) according to claim 20, wherein the preform patch (2) has an inlet connection (110) and a suction connection (114).

24. The preform patch (2) for subsequent reinforcement of a fiber composite component (8) according to claim 20, wherein the preform patch (2) has a gas permeable but matrix material impermeable membrane (18) and a ply of a spacer fabric (20) only in some region or regions.

25. The preform patch (2) for subsequent reinforcement of a fiber composite component (8) according to claim 20, wherein a ply of the flow medium (12) in one section of the preform patch (2) is situated in a plane (24) which is different from the plane (26) of the ply of the flow medium (12) which rests on the fiber ply (4a) of a fiber material, wherein one end of the flow medium (12) situated in the different plane (24) enters the plane (26) of the ply of the flow medium (12) which rests on the fiber ply (4a) of a fiber material.

26. The preform patch (2) for subsequent reinforcement of a fiber composite component (8) according to claim 25, wherein the ply of the flow medium (12), which is arranged in the different plane (24), is laid in a loop (34).

27. The preform patch (2) for subsequent reinforcement of a fiber composite component (8) according to claim 25, wherein the ply of the flow medium (12) which is arranged in the different plane (24), and the gas permeable but matrix material impermeable membrane (18) with the ply of a spacer fabric (20) run at a distance (28) from and in an at least approximately parallel alignment with respect to one another over the length of the preform patch (2).

28. The preform patch (2) for subsequent reinforcement of a fiber composite component (8) according to claim 20, wherein at least two plies of vacuum films (14) form the outer skin of the preform patch (2), wherein the two plies are separated from one another by a suction web (30) arranged between them.

29. The preform patch (2) for subsequent reinforcement of a fiber composite component (8) according to claim 20, wherein the preform patch (2) is stored in roll form.

30. A method of subsequent reinforcement of a fiber composite component (8), wherein the fiber composite component (8) includes at least one fiber ply (4) of a fiber material and a matrix material (6) of a fiber composite, in which the fiber ply of a fiber material is embedded, by means of a preform patch (2), wherein the preform patch (2) has at least one ply of a tear-off fabric (10), characterized in that use is made of a preform patch (2) in which there is arranged, on its side facing the surface of the fiber composite component (8), at least one ply of a tear-off fabric (10) as first ply, above that at least one ply of a flow medium (12), and above that at least one ply of a vacuum film (14), which comprises:
arranging the at least one ply of the flow medium (12) in a distributor space (16);
distributing the matrix material (6) over a fiber ply (4a) of a fiber material, wherein the distributor space (16) is delimited on the side facing away from the fiber composite component (8) by the vacuum film (14) and the preform patch (2) has a gas permeable but matrix material impermeable membrane (18) and a ply of a spacer fabric (20);
arranging the spacer fabric (20) between the matrix material impermeable membrane (18) and the vacuum film (14), wherein the space filled by the spacer fabric (20) forms a suction space (22);
sealing the suction space in a matrix material tight manner with respect to the distributor space (16);
laying the preform patch (2) on a fiber ply (4a) of a fiber material, which has already been laid on the fiber composite component (8), wherein the preform patch (2) is connected in a vacuum-tight manner to the fiber composite component (8); and
introducing matrix material (6) into the preform patch (2) until the fiber ply (4a) of a fiber material is saturated with matrix material (6) and, the matrix material (6) cures;
tearing off the preform patch (2) from the fiber ply (4a) of a fiber material along the ply of the tear-off fabric (10), or the preform patch (2) additionally has a fiber ply (4a) of a fiber material as first ply, above that at least one ply of a tear-off fabric (10), above that at least one ply of a flow medium (12), and above that at least one ply of a vacuum film (14), wherein the spacer fabric (20) is arranged between the matrix material impermeable membrane (18) and the vacuum film (14), and wherein the space filled by the spacer fabric (20) forms a suction space (22);
sealing the suction space (22) in a matrix material tight manner with respect to the distributor space (16);
laying the preform patch (2) with the fiber layer (4a) of a fiber material directly on the surface of the fiber composite component (8), wherein the preform patch (2) is connected in a vacuum-tight manner to the fiber composite component (8);
introducing the matrix material (6) into the preform patch (2) until the fiber ply (4a) of a fiber material is saturated with matrix material (6) and the matrix material (6) cures; and
tearing off the preform patch (2) is then torn off from the fiber ply (4a) of a fiber material along the ply of the tear-off fabric (10).

31. The method of subsequent reinforcement of a fiber composite component (8) according to claim 30, wherein the preform patch (2) includes at least one fiber ply (4) of a fiber material and a matrix material (6) of a fiber composite, in which the fiber ply (4) of a fiber material is embedded, wherein the preform patch (2) has at least one ply (10) of a tear-off fabric (10), characterized in that the preform patch (2) has, on its side facing the surface of the fiber composite component (8), at least one ply of a tear-off fabric (10) as first ply, above that at least one ply of a flow medium (12), and above that at least one ply of a vacuum film (14), wherein the at least one ply of the flow medium (12) can be arranged in a distributor space (16) for distribution of the matrix material (6) over a fiber ply (4a) of a fiber material, the distributor space (16) is delimited on the side facing away from the fiber composite component (8) by the vacuum film (14), and the preform patch (2) has a gas permeable but matrix material impermeable membrane (18) and a ply of a spacer fabric (20), wherein the spacer fabric (20) is arranged between the matrix material impermeable membrane (18) and the vacuum film (14), and wherein the space filled by the spacer fabric (20) forms a suction space (22), which is sealed in a matrix material tight manner with respect to the distributor space (16), wherein the material ply with the membrane (18) and the spacer fabric (20) is arranged in at least one edge region of the flow medium (12), overlapping at least partially with the latter.

32. The method of subsequent reinforcement of a fiber composite component (8) according to claim 30, further comprising laying the preform patch (2) on a surface of the fiber composite component (8) which is not aligned horizontally, and introducing the matrix material (6) into the preform patch (2) at the upper end of the preform patch (2).

33. The method of subsequent reinforcement of a fiber composite component (8) according to claim 30, further comprising feeding the quantity of matrix material (6) into the preform patch (2) that is controlled in such a way that an excess supply of matrix material (6) is formed in the region of the flow medium (12) at the front end of the flow front when viewed in the direction of flow.

34. The method of subsequent reinforcement of a fiber composite component (8) according to claim 30, wherein the preform patch (2) has a gas permeable but matrix material impermeable membrane (18) and a ply of a spacer fabric (20) only in some region or regions, and the preform patch (2) is aligned with the fiber composite component (8) in such a way that the suction space (22) formed by the membrane (18) and the spacer fabric (20) sucks the matrix material (6) through the distributor space (16) in a direction transverse to the horizontal.

35. The method of subsequent reinforcement of a fiber composite component (8) according to claim 30, further comprising:
utilizing the preform patch (2) having a ply of the flow medium (12) in one section of the preform patch (2) is situated in a plane (24), which is different from the plane (26) of the ply of the flow medium (12) which rests on the fiber ply (4a) of a fiber material;
entering the plane (26) of the ply of the flow medium (12), which rests on the fiber ply (4a) of a fiber material with one end of the flow medium (12) situated in the different plane (24); and
feeding the matrix material (6) that is controlled in such a way that a reservoir column of matrix material (6) is formed in the differently laid ply of the flow medium (12), at least in some section or sections.

36. A method of subsequent reinforcement and/or repair of a blade (102) of a fully installed wind turbine (100), the blade (102) being produced from a fiber composite material and comprising at least one fiber ply (4) of a fiber material and a matrix material (6) of a fiber composite, in which the fiber ply (4) of a fiber material is embedded, characterized in that a fiber ply (4a) of a fiber material as first ply, above that at least one ply of a tear-off fabric (10), above that at least one ply of a flow medium (12), comprising:
applying at least one ply of a vacuum film (14) to the surface of the blade (102) on the side to be repaired and/or reinforced, wherein the at least one ply of the flow medium (12) is arranged in a distributor space (16) for distribution of the matrix material (6) over a fiber ply (4a) of a fiber material, the distributor space (16) is delimited on the side facing away from the blade by the vacuum film (14), and the distributor space (16) has a gas permeable but matrix material impermeable membrane (18) and a ply of a spacer fabric (20);
arranging the spacer fabric (20) between the matrix material impermeable membrane (18) and the vacuum film (14), and the space filled by the spacer fabric (20) forms a suction space (22), which is sealed in a matrix material tight manner with respect to the distributor space (16), connecting the above-described material ply in a vacuum-tight manner to the fiber composite component (8);
introducing matrix material (6) into the material ply until the fiber ply (4a) of a fiber material is saturated with matrix material (6);
curing the matrix material (6); and
tearing off the material ply, with the exception of the fiber ply (4a) of a fiber material from the fiber ply (4a) of a fiber material along the ply of the tear-off fabric (10), without detaching the blade (102) from the wind turbine during this process.

37. The method of subsequent reinforcement and/or repair of a blade (102) of a fully installed wind turbine (100) according to claim 36, wherein the preform patch (2) includes at least one fiber ply (4) of a fiber material and a matrix material (6) of a fiber composite, in which the fiber ply (4) of a fiber material is embedded, wherein the preform patch (2) has at least one ply (10) of a tear-off fabric (10), characterized in that the preform patch (2) has, on its side facing the surface of the fiber composite component (8), at least one ply of a tear-off fabric (10) as first ply, above that at least one ply of a flow medium (12), and above that at least one ply of a vacuum film (14), wherein the at least one ply of the flow medium (12) can be arranged in a distributor space (16) for distribution of the matrix material (6) over a fiber ply (4a) of a fiber material, the distributor space (16) is delimited on the side facing away from the fiber composite component (8) by the vacuum film (14), and the preform patch (2) has a gas permeable but matrix material impermeable membrane (18) and a ply of a spacer fabric (20), wherein the spacer fabric (20) is arranged between the matrix material impermeable membrane (18) and the vacuum film (14), and wherein the space filled by the spacer fabric (20) forms a suction space (22), which is sealed in a matrix material tight manner with respect to the distributor space (16).

38. The method of subsequent reinforcement and/or repair of a blade (102) of a fully installed wind turbine (100) according to claim 36, further comprising wherein the fiber composite component (8) includes at least one fiber ply (4) of a fiber material and a matrix material (6) of a fiber composite, in which the fiber ply of a fiber material is embedded, by means of a preform patch (2), wherein the preform patch (2) has at least one ply of a tear-off fabric (10), characterized in that use is made of a preform patch (2) in which there is arranged, on its side facing the surface of the fiber composite component (8), at least one ply of a tear-off fabric (10) as first ply, above that at least one ply of a flow medium (12), and above that at least one ply of a vacuum film (14), which comprises:
arranging the at least one ply of the flow medium (12) in a distributor space (16);
distributing the matrix material (6) over a fiber ply (4a) of a fiber material, wherein the distributor space (16) is delimited on the side facing away from the fiber composite component (8) by the vacuum film (14) and the preform patch (2) has a gas permeable but matrix material impermeable membrane (18) and a ply of a spacer fabric (20);
arranging the spacer fabric (20) between the matrix material impermeable membrane (18) and the vacuum film (14), wherein the space filled by the spacer fabric (20) forms a suction space (22);
sealing the suction space in a matrix material tight manner with respect to the distributor space (16);
laying the preform patch (2) on a fiber ply (4a) of a fiber material, which has already been laid on the fiber composite component (8), wherein the preform patch (2) is connected in a vacuum-tight manner to the fiber composite component (8);
introducing matrix material (6) into the preform patch (2) until the fiber ply (4a) of a fiber material is saturated with matrix material (6) and, the matrix material (6) cures;
tearing off the preform patch (2) from the fiber ply (4a) of a fiber material along the ply of the tear-off fabric (10), or the preform patch (2) additionally has a fiber ply (4a) of a fiber material as first ply, above that at least one ply of a tear-off fabric (10), above that at least one ply of a flow medium (12), and above that at least one ply of a vacuum film (14), wherein the spacer fabric (20) is arranged between the matrix material impermeable membrane (18) and the vacuum film (14), and wherein the space filled by the spacer fabric (20) forms a suction space (22);
sealing the suction space (22) in a matrix material tight manner with respect to the distributor space (16);
laying the preform patch (2) with the fiber layer (4a) of a fiber material directly on the surface of the fiber composite component (8), wherein the preform patch (2) is connected in a vacuum-tight manner to the fiber composite component (8);
introducing the matrix material (6) into the preform patch (2) until the fiber ply (4a) of a fiber material is saturated with matrix material (6) and the matrix material (6) cures; and
tearing off the preform patch (2) is then torn off from the fiber ply (4a) of a fiber material along the ply of the tear-off fabric (10); and
laying the preform patch (2) on a surface of the fiber composite component (8), which is not aligned horizontally, and introducing the matrix material (6) into the preform patch (2) at the upper end of the preform patch (2).
